(19) United States
(12) Patent Application Publication
(10) Pub. No.: US 2026/0281675 A1
(43) Pub. Date: Sep. 17, 2026

(54) SYSTEMS AND METHODS FOR USING BEVS AS PART OF VEHICULAR MICRO CLOUDS

(71) Applicant: TOYOTA MOTOR ENGINEERING & MANUFACTURING NORTH AMERICA, INC., Plano, TX (US)

(72) Inventors: Seyhan Ucar, Mountain View, CA (US); Chunghan Lee, Mountain View, CA (US); Emrah Akin Sisbot, Mountain View, CA (US); Onur Altintas, Mountain View, CA (US); Kentaro Oguchi, Mountain View, CA (US)

(73) Assignees: TOYOTA MOTOR ENGINEERING & MANUFACTURING NORTH AMERICA, INC., Plano, TX (US); TOYOTA JIDOSHA KABUSHIKI KAISHA, Toyota-shi (JP)

(21) Appl. No.: 19/081,888

(22) Filed: Mar. 17, 2025

(51) Int. Cl. H04W 4/44; B60L 53/64; H04W 36/36; H04W 48/18

(52) U.S. Cl. CPC H04W 4/44; B60L 53/64; H04W 36/362; H04W 48/18

(57) ABSTRACT

Systems and methods are provided for adding electric vehicles to a vehicular micro cloud while the vehicle is charging. The system can determine that an electric vehicle has entered an idle phase of charging and select a vehicular micro cloud based on a resource deficiency. The electric vehicle can be added to the vehicular micro cloud, and the system can periodically or continuously monitor the electric vehicle and the vehicular micro cloud to remove the electric vehicle once the electric vehicle is no longer in the idle phase.

### TECHNICAL FIELD

The present disclosure relates generally to vehicular micro clouds (VMCs), and in particular, some implementations may relate to the formation of VMCs to offset battery electric vehicle (BEV) or plug-in hybrid idling.

### DESCRIPTION OF RELATED ART

BEVs or plug-in hybrid vehicles often have idling fees associated with charging the vehicle. Idling fees refer to the time given to EV drivers to unplug their car from the charging station once the vehicle is charged. Exceeding this grace period can result in additional costs to encourage drivers to only use chargers for as long as necessary. These fees can begin accruing once the vehicle has finished charging and remains connected to the charging station for a specified period without actively charging. This grace period can vary by charging network or station, often ranging from a few minutes to an hour. Conventional charging systems do not use vehicle resources during this grace period, such as data storage, data computation, and data transmission or communication.

### BRIEF SUMMARY OF THE DISCLOSURE

According to various embodiments of the disclosed technology, a method can comprise determining an electric vehicle has entered an idle phase of charging; selecting a vehicular micro cloud (VMC) of a plurality of VMCs based on a resource deficiency associated with the selected VMC; adding the electric vehicle to the selected VMC; and periodically or continuously monitoring the electric vehicle and the selected VMC and removing the electric vehicle from the selected VMC once the electric vehicle is no longer in the idle phase.

In some embodiments, the resource deficiency comprises a storage deficiency, a communication deficiency, or a computation deficiency.

In some embodiments, the method further comprises determining that the selected VMC has dispersed and selecting a new VMC for the electric vehicle.

In some embodiments, determining that the electric vehicle has entered the idle phase comprises determining that the electric vehicle is accruing idle charging fees.

In some embodiments, determining that the electric vehicle has entered the idle phase comprises determining that the electric vehicle has exceeded a threshold grace period of idle time.

In some embodiments, the VMC is selected based on matching resources of the electric vehicle with one or more VMC types.

In some embodiments, the VMC is selected based on historical resource profiles of the plurality of VMCs.

In some embodiments, periodically monitoring the electric vehicle and the selected vehicular micro cloud comprises monitoring the historical resource profile of the selected VMC.

According to various embodiments of the disclosed technology, a vehicle can comprise a processor and a memory coupled to the processor to store instructions. The instructions, when executed by the processor, can cause the processor to determine the vehicle has entered an idle phase of charging; select a vehicular micro cloud (VMC) of a plurality of VMCs based on a resource deficiency associated with the selected VMC; add the vehicle to the selected VMC; and determine when the selected VMC has dispersed and select a new VMC for the vehicle.

In some embodiments, the resource deficiency comprises a storage deficiency, a communication deficiency, or a computation deficiency.

In some embodiments, determining that the vehicle has entered the idle phase comprises determining that the vehicle is accruing idle charging fees.

In some embodiments, determining that the vehicle has entered the idle phase comprises determining that the vehicle has exceeded a threshold grace period of idle time.

In some embodiments, the VMC is selected based on matching resources of the vehicle with one or more VMC types.

In some embodiments, the VMC is selected based on historical resource profiles of the plurality of VMCs.

In some embodiments, the processor is further configured to monitor the historical resource profile of the selected VMC.

According to various embodiments of the disclosed technology, a non-transitory machine-readable storage medium can be encoded with instructions, which, when executed by a processor, causes the processor to determine an electric vehicle has entered an idle phase of charging; determine the electric vehicle has exceeded a threshold grace period in the idle phase; select a vehicular micro cloud (VMC) of a plurality of VMCs based on a resource deficiency associated with the selected VMC; add the electric vehicle to the selected VMC; and periodically or continuously monitor the electric vehicle and the selected VMC and remove the electric vehicle from the selected VMC once the electric vehicle is no longer in the idle phase.

In some embodiments, the resource deficiency comprises a storage deficiency, a communication deficiency, or a computation deficiency.

In some embodiments, the processor is further configured to determine that the selected VMC has dispersed and select a new VMC for the electric vehicle.

In some embodiments, the VMC is selected based on matching resources of the electric vehicle with one or more VMC types.

In some embodiments, the VMC is selected based on historical resource profiles of the plurality of VMCs.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a schematic representation of an example vehicle with which embodiments of the systems and methods disclosed herein may be implemented.

FIG. 2 illustrates an example architecture for VMC formation in accordance with one embodiment of the systems and methods described herein.

FIG. 3A illustrates an example system remotely adding a BEV to a VMC in accordance with one embodiment.

FIG. 3B illustrates a first example environment incorporating the addition of a BEV into a VMC accordance with one embodiment.

FIG. 3C illustrates a second example environment incorporating the addition of a BEV into a VMC accordance with one embodiment.

FIG. 4 illustrates an example method for adding a BEV into a VMC in accordance with one embodiment.

FIG. 5 is an example computing component that may be used to implement various features of embodiments described in the present disclosure.

The figures are not exhaustive and do not limit the present disclosure to the precise form disclosed.

### DETAILED DESCRIPTION

A common issue with charging systems that include idling fees is that these systems may not check if charging spots are available for other vehicles. As a result, drivers may be charged idling fees even though other chargers are readily available. To reduce the costs to drivers in these situations, embodiments of the systems and methods disclosed leverage underutilized vehicle resources during the idling period using VMCs. The system may activate if there are other free chargers available or may activate regardless to offset costs to the driver.

VMCs can refer to groups of vehicles that are not limited in size, proximity, and location. Various types of VMCs can be employed depending on the situation. Stationary VMCs may comprise a series of stationary vehicles observing a scene or event (i.e., an accident, hazard, etc.). Mobile VMCs may surround and follow a vehicular micro cloud leader (e.g., the ego vehicle) as the micro cloud leader traverses. Mobile VMCs may link together to form chains of interdependent VMCs. In some embodiments, a vehicle may be a part of more than one VMC. Remote VMCs may be designated at a remote server and generated based on a specific remote location. Vehicles within this remote location may form the remote VMC.

The systems and methods described herein can leverage computational resource abilities during warm-up, charging, and grace phases of vehicle charging operations. The system may analyze the status of charging networks and BEVs to determine the availability of resources and the operational phase of charging for each BEV. In addition, the system may receive requests for computational resources, such as processing, storage, and transmission. These requests can be matched with VMCs operating at charging locations. Once a BEV is matched to a VMC, idle fees may be offset or eliminated based on continuing participation in the VMC.

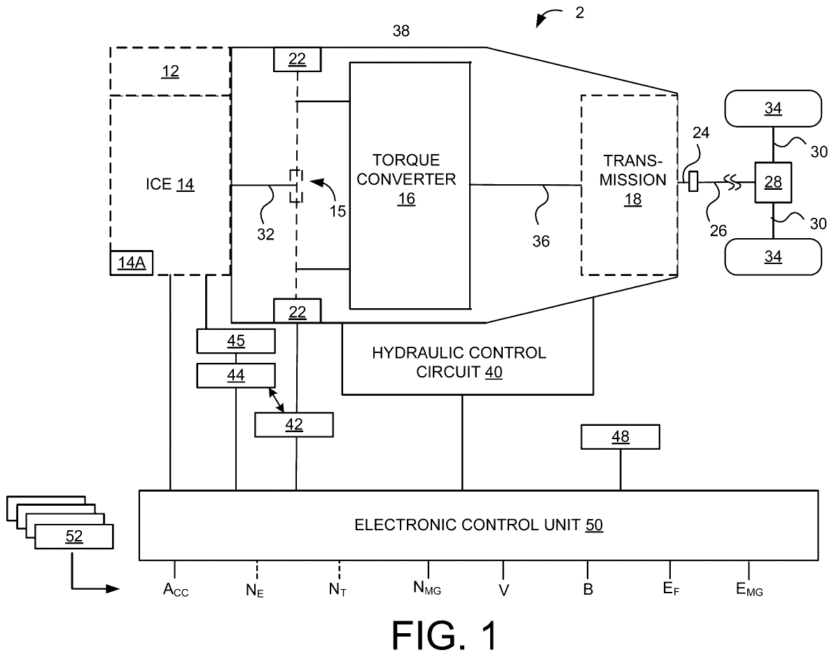

The systems and methods disclosed herein may apply to any BEV or hybrid plug-in vehicle system. The systems and methods disclosed herein may be implemented with any of a number of different vehicles and vehicle types. For example, the systems and methods disclosed herein may be used with automobiles, trucks, motorcycles, recreational vehicles and other like on-or off-road vehicles. In addition, the principals disclosed herein may also extend to other vehicle types as well. Although the example described with reference to FIG. 1 is a hybrid type of vehicle, the systems and methods incorporating VMCs can be implemented in other types of vehicles including gasoline-or diesel-powered vehicles, fuel-cell vehicles, electric vehicles, or other vehicles.

FIG. 1 illustrates a drive system of a vehicle 100 that may include an internal combustion engine 14 and one or more electric motors 22 (which may also serve as generators) as sources of motive power. Driving force generated by the internal combustion engine 14 and motors 22 can be transmitted to one or more wheels 34 via a torque converter 16, a transmission 18, a differential gear device 28, and a pair of axles 30.

As an HEV or BEV, vehicle 2 may be driven/powered with either or both of engine 14 and the motor(s) 22 as the drive source for travel. For example, a first travel mode may be an engine-only travel mode that only uses internal combustion engine 14 as the source of motive power. A second travel mode may be an EV travel mode that only uses the motor(s) 22 as the source of motive power. A third travel mode may be an HEV travel mode that uses engine 14 and the motor(s) 22 as the sources of motive power. In the engine-only and HEV travel modes, vehicle 100 relies on the motive force generated at least by internal combustion engine 14, and a clutch 15 may be included to engage engine 14. In the EV travel mode, vehicle 2 is powered by the motive force generated by motor 22 while engine 14 may be stopped and clutch 15 disengaged.

Engine 14 can be an internal combustion engine such as a gasoline, diesel or similarly powered engine in which fuel is injected into and combusted in a combustion chamber. A cooling system 12 can be provided to cool the engine 14 such as, for example, by removing excess heat from engine 14. For example, cooling system 12 can be implemented to include a radiator, a water pump and a series of cooling channels. In operation, the water pump circulates coolant through the engine 14 to absorb excess heat from the engine. The heated coolant is circulated through the radiator to remove heat from the coolant, and the cold coolant can then be recirculated through the engine. A fan may also be included to increase the cooling capacity of the radiator. The water pump, and in some instances the fan, may operate via a direct or indirect coupling to the driveshaft of engine 14. In other applications, either or both the water pump and the fan may be operated by electric current such as from battery 44.

An output control circuit 14A may be provided to control drive (output torque) of engine 14. Output control circuit 14A may include a throttle actuator to control an electronic throttle valve that controls fuel injection, an ignition device that controls ignition timing, and the like. Output control circuit 14A may execute output control of engine 14 according to a command control signal(s) supplied from an electronic control unit 50, described below. Such output control can include, for example, throttle control, fuel injection control, and ignition timing control.

Motor 22 can also be used to provide motive power in vehicle 2 and is powered electrically via a battery 44. Battery 44 may be implemented as one or more batteries or other power storage devices including, for example, lead-acid batteries, nickel-metal hydride batteries, lithium-ion batteries, capacitive storage devices, and so on. Battery 44 may be charged by a battery charger 45 that receives energy from internal combustion engine 14. For example, an alternator or generator may be coupled directly or indirectly to a drive shaft of internal combustion engine 14 to generate an electrical current as a result of the operation of internal combustion engine 14. A clutch can be included to engage/disengage the battery charger 45. Battery 44 may also be charged by motor 22 such as, for example, by regenerative braking or by coasting during which time motor 22 operate as generator.

Motor 22 can be powered by battery 44 to generate a motive force to move the vehicle and adjust vehicle speed. Motor 22 can also function as a generator to generate electrical power such as, for example, when coasting or braking. Battery 44 may also be used to power other electrical or electronic systems in the vehicle. Motor 22 may be connected to battery 44 via an inverter 42. Battery 44 can include, for example, one or more batteries, capacitive storage units, or other storage reservoirs suitable for storing electrical energy that can be used to power motor 22. When battery 44 is implemented using one or more batteries, the batteries can include, for example, nickel metal hydride batteries, lithium-ion batteries, lead acid batteries, nickel cadmium batteries, lithium-ion polymer batteries, and other types of batteries.

An electronic control unit 50 (described below) may be included and may control the electric drive components of the vehicle as well as other vehicle components. For example, electronic control unit 50 may control inverter 42, adjust driving current supplied to motor 22, and adjust the current received from motor 22 during regenerative coasting and breaking. As a more particular example, output torque of the motor 22 can be increased or decreased by electronic control unit 50 through the inverter 42.

A torque converter 16 can be included to control the application of power from engine 14 and motor 22 to transmission 18. Torque converter 16 can include a viscous fluid coupling that transfers rotational power from the motive power source to the driveshaft via the transmission. Torque converter 16 can include a conventional torque converter or a lockup torque converter. In other embodiments, a mechanical clutch can be used in place of torque converter 16.

Clutch 15 can be included to engage and disengage engine 14 from the drivetrain of the vehicle. In the illustrated example, a crankshaft 32, which is an output member of engine 14, may be selectively coupled to the motor 22 and torque converter 16 via clutch 15. Clutch 15 can be implemented as, for example, a multiple disc type hydraulic frictional engagement device whose engagement is controlled by an actuator such as a hydraulic actuator. Clutch 15 may be controlled such that its engagement state is complete engagement, slip engagement, and complete disengagement complete disengagement, depending on the pressure applied to the clutch. For example, a torque capacity of clutch 15 may be controlled according to the hydraulic pressure supplied from a hydraulic control circuit (not illustrated). When clutch 15 is engaged, power transmission is provided in the power transmission path between the crankshaft 32 and torque converter 16. On the other hand, when clutch 15 is disengaged, motive power from engine 14 is not delivered to the torque converter 16. In a slip engagement state, clutch 15 is engaged, and motive power is provided to torque converter 16 according to a torque capacity (transmission torque) of the clutch 15.

As alluded to above, vehicle 100 may include an electronic control unit 50. Electronic control unit 50 may include circuitry to control various aspects of the vehicle operation. Electronic control unit 50 may include, for example, a microcomputer that includes a one or more processing units (e.g., microprocessors), memory storage (e.g., RAM, ROM, etc.), and I/O devices. The processing units of electronic control unit 50, execute instructions stored in memory to control one or more electrical systems or subsystems in the vehicle. Electronic control unit 50 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., ABS or ESC), battery management systems, and so on. These various control units can be implemented using two or more separate electronic control units or using a single electronic control unit.

In the example illustrated in FIG. 1, electronic control unit 50 receives information from a plurality of sensors included in vehicle 100. For example, electronic control unit 50 may receive signals that indicate vehicle operating conditions or characteristics, or signals that can be used to derive vehicle operating conditions or characteristics. These may include, but are not limited to accelerator operation amount, A_{CC}, a revolution speed, N_{E}, of internal combustion engine 14 (engine RPM), a rotational speed, N_{MG}, of the motor 22 (motor rotational speed), and vehicle speed, N_{V}. These may also include torque converter 16 output, N_{T} (e.g., output amps indicative of motor output), brake operation amount/pressure, B, battery SOC (i.e., the charged amount for battery 44 detected by an SOC sensor). Accordingly, vehicle 100 can include a plurality of sensors 52 that can be used to detect various conditions internal or external to the vehicle and provide sensed conditions to engine control unit 50 (which, again, may be implemented as one or a plurality of individual control circuits). In one embodiment, sensors 52 may be included to detect one or more conditions directly or indirectly such as, for example, fuel efficiency, E_{F}, motor efficiency, E_{MG}, hybrid (internal combustion engine 14+MG 12) efficiency, acceleration, A_{CC}, etc.

In some embodiments, one or more of the sensors 52 may include their own processing capability to compute the results for additional information that can be provided to electronic control unit 50. In other embodiments, one or more sensors may be data-gathering-only sensors that provide only raw data to electronic control unit 50. In further embodiments, hybrid sensors may be included that provide a combination of raw data and processed data to electronic control unit 50. Sensors 52 may provide an analog output or a digital output.

Sensors 52 may be included to detect not only vehicle conditions but also to detect external conditions as well. Sensors that might be used to detect external conditions can include, for example, sonar, radar, lidar or other vehicle proximity sensors, and cameras or other image sensors. Image sensors can be used to detect, for example, traffic signs indicating a current speed limit, road curvature, obstacles, and so on. Still other sensors may include those that can detect road grade. While some sensors can be used to actively detect passive environmental objects, other sensors can be included and used to detect active objects such as those objects used to implement smart roadways that may actively transmit and/or receive data or other information.

The example of FIG. 1 is provided for illustration purposes only as one example of vehicle systems with which embodiments of the disclosed technology may be implemented. One of ordinary skill in the art reading this description will understand how the disclosed embodiments can be implemented with this and other vehicle platforms.

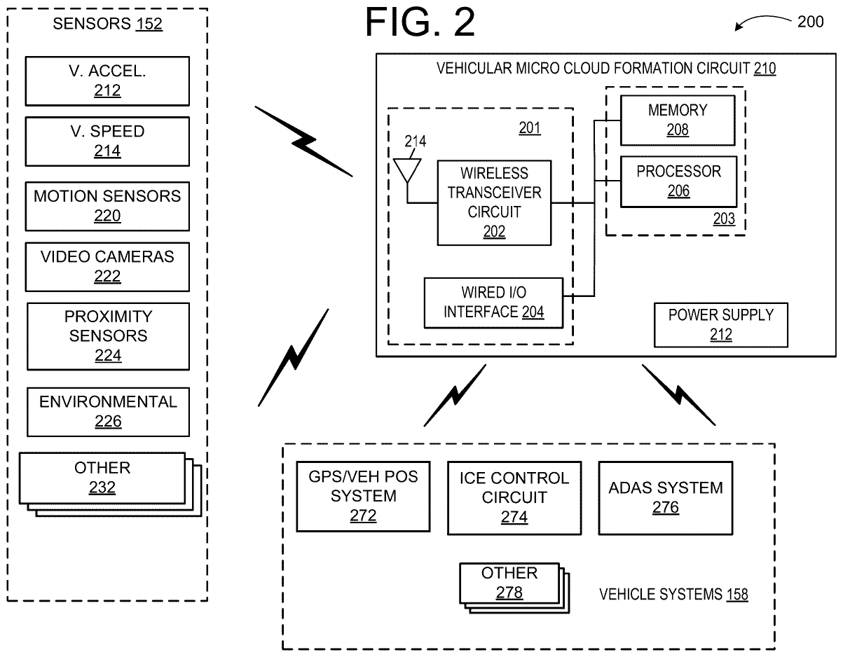

FIG. 2 illustrates an example architecture for VMC formation in accordance with one embodiment of the systems and methods described herein. In some embodiments, VMC formation system 200 can be implemented in-vehicle to execute while a driver is operating the vehicle. In other embodiments, VMC formation system 200 can operate over a cloud or other network. Referring now to FIG. 2, in this example, VMC formation system 200 includes a VMC formation circuit 210, a plurality of sensors 152 and a plurality of vehicle systems 158.

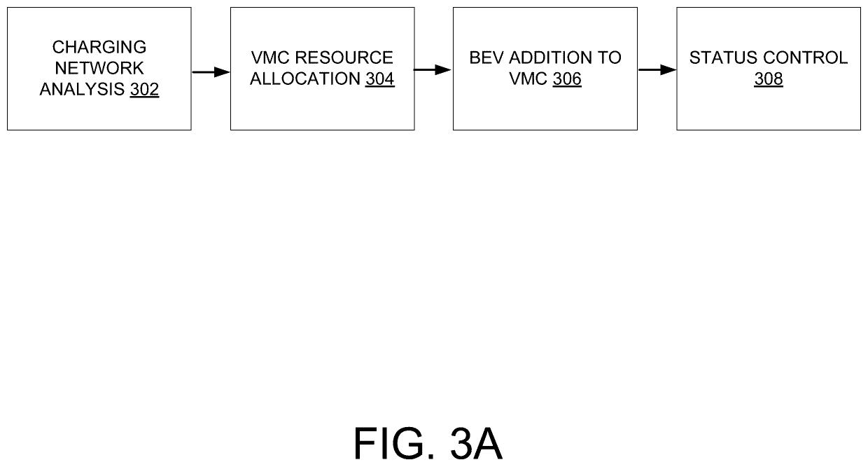

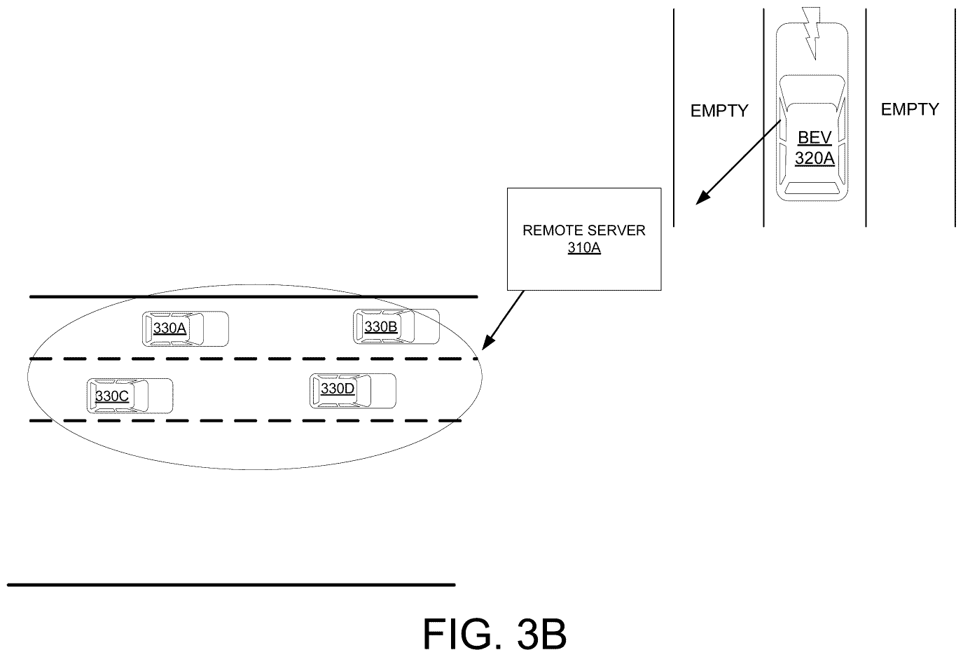

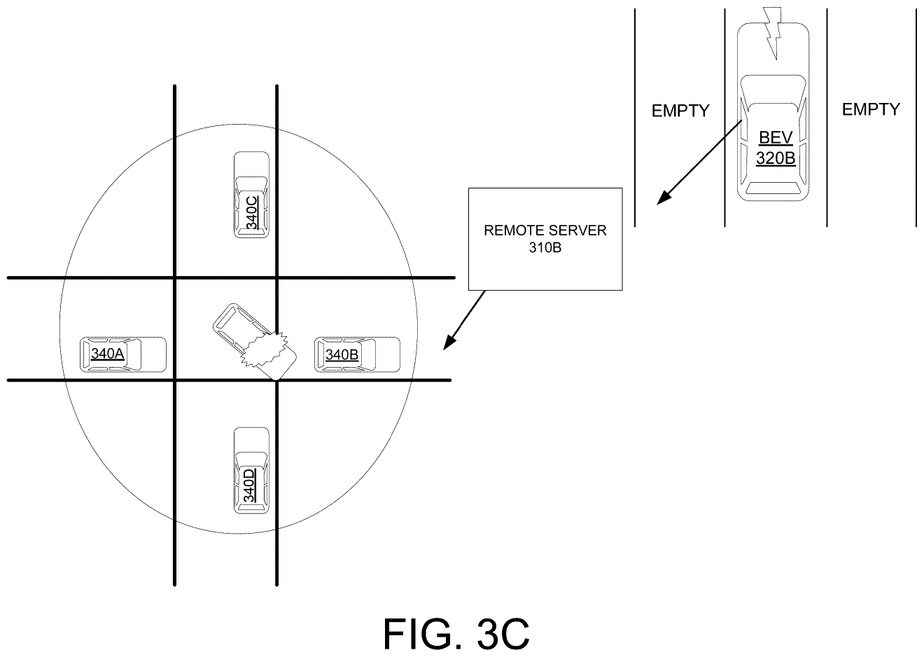

Sensors 152 and vehicle systems 158 can communicate with VMC formation circuit 210 via a wired or wireless communication interface. Although sensors 152 and vehicle systems 158 are depicted as communicating with VMC formation circuit 210, they can also communicate with each other as well as with other vehicle systems. In embodiments where VMC formation circuit 210 is implemented in-vehicle, VMC formation circuit 210 can be implemented as an ECU or as part of an ECU such as, for example electronic control unit 50. In other embodiments, VMC formation circuit 210 can be implemented independently of the ECU, such that sensors 152 and vehicle systems 158 can communicate to VMC formation circuit 210 over a network, server or cloud interface. In embodiments where VMC formation circuit 210 operates over a network, VMC formation circuit 210 can execute the architecture described below in FIGS. 3A-C, 4, and 5 and communicate back to sensors 152 and vehicle systems 158.

VMC formation circuit 210 in this example includes a communication circuit 201, a decision circuit 203 (including a processor 206 and memory 208 in this example) and a power supply 212. Components of VMC formation circuit 210 are illustrated as communicating with each other via a data bus, although other communication in interfaces can be included.

Processor 206 can include one or more GPUs, CPUs, microprocessors, or any other suitable processing system. Processor 206 may include a single core or multicore processors. The memory 208 may include one or more various forms of memory or data storage (e.g., flash, RAM, etc.) that may be used to store the calibration parameters, images (analysis or historic), point parameters, instructions and variables for processor 206 as well as any other suitable information. Memory 208 can be made up of one or more modules of one or more different types of memory and may be configured to store data and other information as well as operational instructions that may be used by the processor 206 to VMC formation circuit 210.

Although the example of FIG. 2 is illustrated using processor and memory circuitry, as described below with reference to circuits disclosed herein, decision circuit 203 can be implemented utilizing any form of circuitry including, for example, hardware, software, or a combination thereof. By way of further example, one or more processors, controllers, ASICs, PLAs, PALs, CPLDs, FPGAs, logical components, software routines or other mechanisms might be implemented to make up a VMC formation circuit 210.

Communication circuit 201 either or both a wireless transceiver circuit 202 with an associated antenna 205 and a wired I/O interface 204 with an associated hardwired data port (not illustrated). Communication circuit 201 can provide for V2X and/or V2V communications capabilities, allowing VMC formation circuit 210 to communicate with edge devices, such as roadside unit/equipment (RSU/RSE), network cloud servers and cloud-based databases, and/or other vehicles via a network. For example, V2X communication capabilities allows VMC formation circuit 210 to communicate with edge/cloud devices, roadside infrastructure (e.g., such as roadside equipment/roadside unit, which may be a vehicle-to-infrastructure (V2I)-enabled streetlight or cameras, for example), etc. Local VMC formation circuit 210 may also communicate with other connected vehicles over vehicle-to-vehicle (V2V) communications.

As used herein, “connected vehicle” refers to a vehicle that is actively connected to edge devices, other vehicles, and/or a cloud server via a network through V2X, V2I, and/or V2V communications. An “unconnected vehicle” refers to a vehicle that is not actively connected. That is, for example, an unconnected vehicle may include communication circuitry capable of wireless communication (e.g., V2X, V2I, V2V, etc.), but for whatever reason is not actively connected to other vehicles and/or communication devices. For example, the capabilities may be disabled, unresponsive due to low signal quality, etc. Further, an unconnected vehicle, in some embodiments, may be incapable of such communication, for example, in a case where the vehicle does not have the hardware/software providing such capabilities installed therein. In some embodiments, a BEV or plug-in hybrid may not be connected to other vehicles when executing the systems and methods described herein. For example, some charging infrastructures connect the vehicle to the internet when connected.

As this example illustrates, communications with VMC formation circuit 210 can include either or both wired and wireless communications circuits 201. Wireless transceiver circuit 202 can include a transmitter and a receiver (not shown) to allow wireless communications via any of a number of communication protocols such as, for example, WiFi®, Bluetooth, near field communications (NFC), Zigbee, and any of a number of other wireless communication protocols whether standardized, proprietary, open, point-to-point, networked or otherwise. Antenna 205 is coupled to wireless transceiver circuit 202 and is used by wireless transceiver circuit 202 to transmit radio signals wirelessly to wireless equipment with which it is connected and to receive radio signals as well. These RF signals can include information of almost any sort that is sent or received by VMC formation circuit 210 to/from other entities such as sensors 152 and vehicle systems 158.

Wired I/O interface 204 can include a transmitter and a receiver (not shown) for hardwired communications with other devices. For example, wired I/O interface 204 can provide a hardwired interface to other components, including sensors 152 and vehicle systems 158. Wired I/O interface 204 can communicate with other devices using Ethernet or any of a number of other wired communication protocols whether standardized, proprietary, open, point-to-point, networked or otherwise.

Power supply 210 can include one or more of a battery or batteries (such as, e.g., Li-ion, Li-Polymer, NiMH, NiCd, NiZn, and NiH₂, to name a few, whether rechargeable or primary batteries,), a power connector (e.g., to connect to vehicle supplied power, etc.), an energy harvester (e.g., solar cells, piezoelectric system, etc.), or it can include any other suitable power supply.

Sensors 152 can include, for example, sensors 52 such as those described above with reference to the example of FIG. 1. Sensors 152 can include additional sensors that may or may not otherwise be included on a standard vehicle 10 with which VMC formation system 200 is implemented. In the illustrated example, sensors 152 include vehicle acceleration sensors 212, vehicle speed sensors 214, motion sensors 220 (providing up to a 360 degree view surrounding the vehicle), video cameras (e.g., to record activity behind, to the side, or in front of the vehicle), proximity sensors 224 (to detect distances between the vehicle and surrounding or approaching vehicles), and environmental sensors 226 (e.g., to detect salinity or other environmental conditions). Additional sensors 232 can also be included as may be appropriate for a given implementation of VMC formation system 200.

Vehicle systems 158 can include any of a number of different vehicle components or subsystems used to control or monitor various aspects of the vehicle and its performance. In this example, the vehicle systems 158 include a GPS or other vehicle positioning system 272; engine control circuits 274 to control the operation of engine (e.g. Internal combustion engine 14); Advanced Driver Assistance (ADAS) system 276 (to engage autonomous driving) and other vehicle systems 280. VMC formation circuit 210 can communicate with ADAS system 276 to engage in autonomous driving assistance or control vis-a-vis controlling or instructing engine operation. That is, ADAS may control or send instructions to engine control components to move the vehicle to one or more locations for purposes of forming the VMC.

Communication circuit 201 can be used to transmit and receive information between VMC formation circuit 210 and sensors 152, and VMC formation circuit 210 and vehicle systems 158. Also, sensors 152 may communicate with vehicle systems 158 directly or indirectly (e.g., via communication circuit 201 or otherwise).

FIG. 3A illustrates an example system for leveraging BEVs in a VMC. At block 302, the system can conduct a charging network analysis to determine areas where a BEV's resources can be used. As mentioned above, in some embodiments, the vehicle can be connected to the internet when connected to the charging infrastructure. The system can determine various parameters associated with the charging infrastructure, including, but not limited to the number of vehicles charging in the current charging infrastructure; vehicles diverting the charging infrastructure; charging speed; and/or network load balancing. The system can also evaluate parameters associated with individual BEVs in the charging infrastructure including, but not limited to available resource profiles; warm up times; and/or time intervals associated with idle fees. In some embodiments, the charging infrastructure stores data on the above parameters and can provide this data to the system upon request. The system can retrieve this information to determine a current status of the charging infrastructure and the charging BEVs.

At block 304, the system can conduct VMC resource allocation based on the charging status. In some embodiments, the type of VMC may inform the system on the required resources. For example, stationary VMCs may require an increased storage capacity to accumulate and retain data. As another example, mobile VMCs may require enhanced computational resources to facilitate task offloading between vehicles. As another example, VMC chains may require storage for use in intermediate data processing between chain links in the VMC. In some embodiments, the VMC leader can determine the required resources and transmit requests to the system. In some embodiments, the VMC leader can be the charging BEV, another vehicle, or a remote server.

It should be noted that embodiments of the disclosed technology contemplate various ways in which a VMC may be generated or used. In some embodiments, the BEV may be deemed to be or elected to be a micro cloud leader. In such embodiments, the micro cloud leader may use an internal VMC formation circuit (e.g. VMC formation circuit 210) to communicate with vehicles to be added to the VMC. In other embodiments, the ego vehicle may communicate with a remote server to generate the VMC and communicate the designation to other vehicles. As the micro cloud leader, the ego vehicle can also obtain/provide substantially constant/up-to-date sensor data from the vehicle's sensors (e.g. sensors 152), avoiding a need to communicate with potentially different RSE or connected vehicles that may be relevant in one period and not relevant in a subsequent period, and so on. Other types of VMCs contemplated by various embodiments includes chained, interdependent micro clouds that can work together. For example, a first micro cloud may reorganize and provide sensor data to a second/next vehicular micro cloud, and so on, the result being a chain of micro clouds that “follows” the travel of the VMCs. Certain connected vehicles may be traveling such that they enter another/next micro cloud.

Once resource allocation is complete, the system can match the BEV to the VMC at block 306. In some embodiments, the system may assign the first available BEV to VMCs without considering any constraints or optimization criteria. In other embodiments, the system can apply pre-established criteria to match BEV resources. The criteria may be based on BEV or situation status. For instance, the BEV may be associated with a premium or subscriber account. As another example, the type of emergency or event triggering the VMC may inform the system which BEV to use. In some embodiments, the consumption of computation resources can affect the selection of a BEV. Preestablished criteria may be stored in a lookup table and/or remote server to be used. When a BEV connects to a charging infrastructure, the system can be triggered to apply the criteria accordingly. In other embodiments, the system can train a machine learning model using historical resource profiles of VMCs. By inputting the resource requirements of BEVs, the machine learning model can predict and assign suitable BEVs to VMCs. At block 308, the system can periodically monitor the status of the BEV and the VMC to determine if the VMC still requires resources, if the BEV can still provide the required resources, or if the BEV has been disconnected from the charging infrastructure. The system can disconnect the BEV from the VMC when appropriate.

FIGS. 3B and 3C illustrate example scenarios where a BEV can be added to a VMC. As illustrated in FIGS. 3B and 3C, BEVs 320A and 320B can be assigned to distinct VMC types according to their specific resource needs. In FIG. 3B, BEV 320A can connect to VMC 330 through remote server 310A. VMC 330 can be a mobile VMC that requires additional computational resources to facilitate task offloading between moving vehicles. The system can determine that BEV 320A has the computational resources available and can add BEV 320A to VMC 330. In some embodiments, BEV 320A may have some computational resources available, but not enough to satisfy all needs VMC 330. The system can add BEV 320A to VMC 330 to partially fulfill the computational needs. The system can continue to add additional BEVs to the VMC until all computational needs are satisfied. As illustrated in FIG. 3C, BEV 320B can connect to VMC 340 through remote server 310B. In this example, VMC 340 can be a stationary VMC located at the scene of an accident. VMC 340 may require additional storage resources to retain the accumulated data from the scene of the accident. The system can determine that BEV 320B has storage resources available and can add BEV 320B to VMC 340. In some embodiments, the system can add BEV 320B to the VMC if a portion of the storage requirements are satisfied. The system can continue to add BEVs as needed to the VMC to satisfy the total storage requirements.

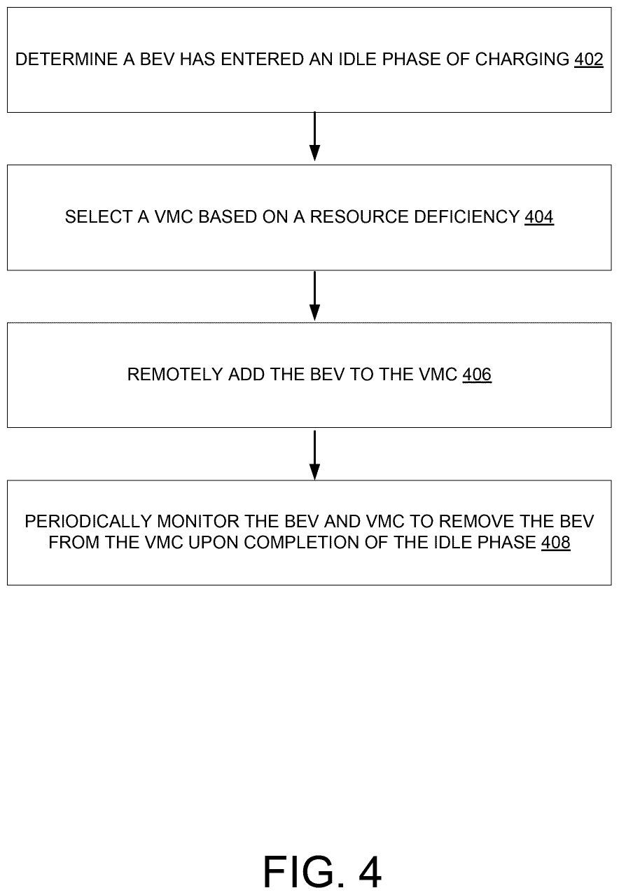

FIG. 4 illustrates an example method for adding a BEV to a VMC, in accordance with the embodiments described above. At block 402, the system can determine that a BEV has entered an idle phase of charging. In some embodiments, the system can check if the BEV is accruing idle charging fees. Based on the fee accrual, the system can determine that the BEV entered the idle phase. In other embodiments, the system can evaluate whether a threshold grace period of idle time has been exceeded. For example, a vehicle may reach full charge and still be connected to a charger for longer than fifteen minutes. Once that time period has passed, the system may determine that the vehicle will begin accruing idle fees and can trigger the resource allocation process. As described above, a charging network analysis can be conducted to determine areas where a BEV's resources can be used. The system can determine various parameters associated with the charging infrastructure. The system can also evaluate parameters associated with individual BEVs in the charging infrastructure. In some embodiments, the charging infrastructure can store this data and provide it to the system upon request.

At block 404, the system can select a VMC of a plurality of VMCs based on a resource deficiency associated with the selected VMC. In some embodiment, a resource deficiency may comprise a storage deficiency, a communication or transmission deficiency, or a computation deficiency. As described above, the system can conduct VMC resource allocation based on the charging status. In some embodiments, the type of VMC may inform the system on the required resources. Once resource allocation is complete, the system can match the BEV to the VMC. In some embodiments, the system may assign the first available BEV to VMCs without considering any constraints or optimization criteria. In other embodiments, the system can apply pre-established criteria to match BEV resources. In other embodiments, the system can train a machine learning model using historical resource profiles of VMCs. In some embodiments, the VMC can be selected based on matching the BEV's resources with one or more VMC types. In other embodiments, the VMC can be selected based on historical resource profiles of the plurality of VMCs. At block 406, the BEV can be remotely added to the selected VMC. In some embodiments, the BEV may be added without the use of a remote server. For example, a stationary VMC may be physically close to the charging station. In this case, the BEV and VMC can leverage vehicle-to-vehicle communication without a remote server.

At block 408, the BEV and the VMC can be periodically monitored. In some embodiments, monitoring can be accomplished with the historical resource profile of the selected VMC. The system can remove the BEV from the selected VMC once the BEV is no longer in the idle phase. Alternatively, the system may determine that the VMC has dispersed. If the BEV is still in the idle charging phase, the system can select a new VMC for the BEV to assist.

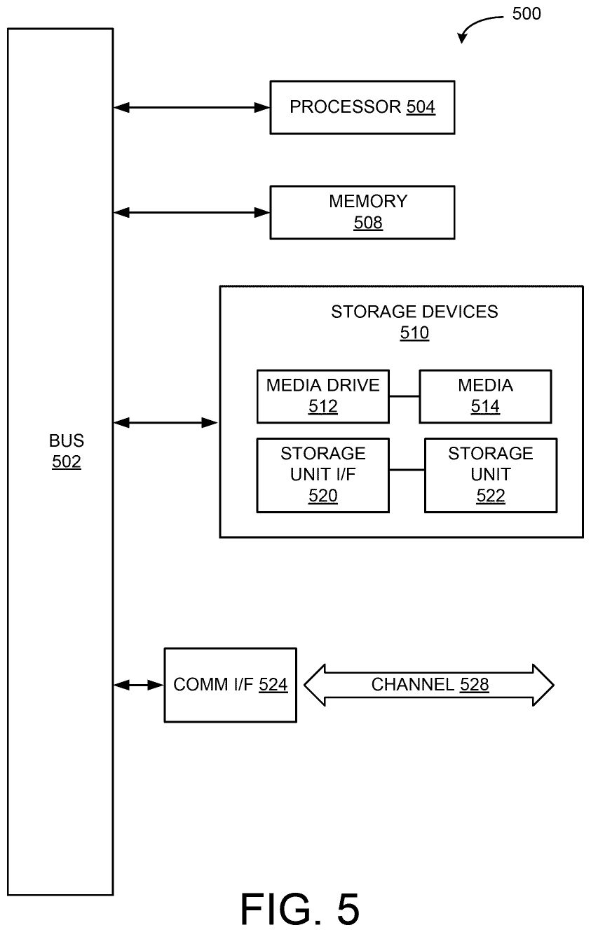

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionalities can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 5. Various embodiments are described in terms of this example-computing component 500. After reading this description, it will become apparent to a person skilled in the relevant art how to implement the application using other computing components or architectures.

Referring now to FIG. 5, computing component 500 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 500 might also represent computing capabilities embedded within or otherwise available to a given device. For example, a computing component might be found in other electronic devices such as, for example, portable computing devices, and other electronic devices that might include some form of processing capability.

Computing component 500 might include, for example, one or more processors, controllers, control components, or other processing devices. Processor 504 might be implemented using a general-purpose or special-purpose processing engine such as, for example, a microprocessor, controller, or other control logic. Processor 504 may be connected to a bus 502. However, any communication medium can be used to facilitate interaction with other components of computing component 500 or to communicate externally.

Computing component 500 might also include one or more memory components, simply referred to herein as main memory 508. For example, random access memory (RAM) or other dynamic memory, might be used for storing information and instructions to be executed by processor 504. Main memory 508 might also be used for storing temporary variables or other intermediate information during execution of instructions to be executed by processor 504. Computing component 500 might likewise include a read only memory (“ROM”) or other static storage device coupled to bus 502 for storing static information and instructions for processor 504.

The computing component 500 might also include one or more various forms of information storage mechanism 510, which might include, for example, a media drive 512 and a storage unit interface 520. The media drive 512 might include a drive or other mechanism to support fixed or removable storage media 514. For example, a hard disk drive, a solid-state drive, a magnetic tape drive, an optical drive, a compact disc (CD) or digital video disc (DVD) drive (R or RW), or other removable or fixed media drive might be provided. Storage media 514 might include, for example, a hard disk, an integrated circuit assembly, magnetic tape, cartridge, optical disk, a CD or DVD. Storage media 514 may be any other fixed or removable medium that is read by, written to or accessed by media drive 512. As these examples illustrate, the storage media 514 can include a computer usable storage medium having stored therein computer software or data.

In alternative embodiments, information storage mechanism 510 might include other similar instrumentalities for allowing computer programs or other instructions or data to be loaded into computing component 500. Such instrumentalities might include, for example, a fixed or removable storage unit 522 and an interface 520. Examples of such storage units 522 and interfaces 520 can include a program cartridge and cartridge interface, a removable memory (for example, a flash memory or other removable memory component) and memory slot. Other examples may include a PCMCIA slot and card, and other fixed or removable storage units 522 and interfaces 520 that allow software and data to be transferred from storage unit 522 to computing component 500.

Computing component 500 might also include a communications interface 524. Communications interface 524 might be used to allow software and data to be transferred between computing component 500 and external devices. Examples of communications interface 524 might include a modem or softmodem, a network interface (such as Ethernet, network interface card, IEEE 502.XX or other interface). Other examples include a communications port (such as for example, a USB port, IR port, RS232 port Bluetooth® interface, or other port), or other communications interface. Software/data transferred via communications interface 524 may be carried on signals, which can be electronic, electromagnetic (which includes optical) or other signals capable of being exchanged by a given communications interface 524. These signals might be provided to communications interface 524 via a channel 528. Channel 528 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 508, storage unit 520, media 514, and channel 528. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 500 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method comprising:
determining an electric vehicle has entered an idle phase of charging;
selecting a vehicular micro cloud (VMC) of a plurality of VMCs based on a resource deficiency associated with the selected VMC;
adding the electric vehicle to the selected VMC; and
periodically or continuously monitoring the electric vehicle and the selected VMC and removing the electric vehicle from the selected VMC once the electric vehicle is no longer in the idle phase.

2. The method of claim 1, wherein the resource deficiency comprises a storage deficiency, a communication deficiency, or a computation deficiency.

3. The method of claim 1, further comprising determining that the selected VMC has dispersed and selecting a new VMC for the electric vehicle.

4. The method of claim 1, wherein determining that the electric vehicle has entered the idle phase comprises determining that the electric vehicle is accruing idle charging fees.

5. The method of claim 4, wherein determining that the electric vehicle has entered the idle phase comprises determining that the electric vehicle has exceeded a threshold grace period of idle time.

6. The method of claim 1, wherein the VMC is selected based on matching resources of the electric vehicle with one or more VMC types.

7. The method of claim 1, wherein the VMC is selected based on historical resource profiles of the plurality of VMCs.

8. The method of claim 7, wherein periodically monitoring the electric vehicle and the selected vehicular micro cloud comprises monitoring the historical resource profile of the selected VMC.

9. A vehicle, comprising:
a processor; and
a memory coupled to the processor to store instructions, which when executed by the processor, causes the processor to:
determine the vehicle has entered an idle phase of charging;
select a vehicular micro cloud (VMC) of a plurality of VMCs based on a resource deficiency associated with the selected VMC;
add the vehicle to the selected VMC; and
determine when the selected VMC has dispersed and select a new VMC for the vehicle.

10. The vehicle of claim 9, wherein the resource deficiency comprises a storage deficiency, a communication deficiency, or a computation deficiency.

11. The vehicle of claim 9, wherein determining that the vehicle has entered the idle phase comprises determining that the vehicle is accruing idle charging fees.

12. The vehicle of claim 11, wherein determining that the vehicle has entered the idle phase comprises determining that the vehicle has exceeded a threshold grace period of idle time.

13. The vehicle of claim 9, wherein the VMC is selected based on matching resources of the vehicle with one or more VMC types.

14. The vehicle of claim 9, wherein the VMC is selected based on historical resource profiles of the plurality of VMCs.

15. The vehicle of claim 14, wherein the processor is further configured to monitor the historical resource profile of the selected VMC.

16. A non-transitory machine-readable storage medium encoded with instructions, which, when executed by a processor, causes the processor to:
determine an electric vehicle has entered an idle phase of charging;
determine the electric vehicle has exceeded a threshold grace period in the idle phase;
select a vehicular micro cloud (VMC) of a plurality of VMCs based on a resource deficiency associated with the selected VMC;
add the electric vehicle to the selected VMC; and
periodically or continuously monitor the electric vehicle and the selected VMC and remove the electric vehicle from the selected VMC once the electric vehicle is no longer in the idle phase.

17. The non-transitory machine-readable storage medium of claim 16, wherein the resource deficiency comprises a storage deficiency, a communication deficiency, or a computation deficiency.

18. The non-transitory machine-readable storage medium of claim 16, wherein the processor is further configured to determine that the selected VMC has dispersed and select a new VMC for the electric vehicle.

19. The non-transitory machine-readable storage medium of claim 16, wherein the VMC is selected based on matching resources of the electric vehicle with one or more VMC types.

20. The non-transitory machine-readable storage medium of claim 16, wherein the VMC is selected based on historical resource profiles of the plurality of VMCs.
